(19) United States
(12) Patent Application Publication
(10) Pub. No.: US 2022/0017756 A1
(43) Pub. Date: Jan. 20, 2022

(54) COMPOSITE PAINT OF PROJECTION SCREEN AND PREPARATION METHOD FOR PROJECTION SCREEN

(71) Applicant: APPOTRONICS CORPORATION LIMITED, Shenzhen, Guangdong (CN)

(72) Inventors: Kejian Cui, Shenzhen, Guangdong (CN); Fei Hu, Shenzhen, Guangdong (CN); Jie Wang, Shenzhen, Guangdong (CN); Yi Li, Shenzhen, Guangdong (CN)

(21) Appl. No.: 17/299,763

(22) PCT Filed: Nov. 18, 2019
(86) PCT No.: PCT/CN2019/119138

§ 371 Date: Jun. 3, 2021

(30) Foreign Application Priority Data
Dec. 3, 2018 (CN) 201811465662.0

(51) Int. Cl. C09D 5/33; C09D 4/00; C09D 7/61; C09D 7/40; C09D 7/20; C09D 175/14; C09D 167/06; C09D 171/00; C09D 163/10; C09D 133/04

(52) U.S. Cl. CPC C09D 5/004; C09D 4/00; C09D 7/61; C09D 7/67; C09D 7/68; C09D 7/69; C09D 133/04; C09D 7/70; C09D 175/14; C09D 167/06; C09D 171/00; C09D 163/10; C09D 7/20

(57) ABSTRACT

Combined coating of a projection screen, comprising light-absorbing coating and reflective coating. The light-absorbing coating comprises 28-32 parts by weight of acrylate, 28-32 parts by weight of reactive diluent, 1-3 parts by weight of photoinitiator, 1-3 parts by weight of black pigment, 20-28 parts by weight of solvent, and 1-5 parts by weight of promoter. The reflective coating comprises 28-32 parts by weight of acrylate, 28-32 parts by weight of reactive diluent, 1-3 parts by weight of photoinitiator, 18-23 parts by weight of aluminum silver powder, 26-32 parts by weight of solvent and 1-5 parts by weight of promoter.

### TECHNICAL FIELD

The present disclosure relates to a composite paint of a projection screen and a preparation method for the projection screen, belonging to the technical field of display screen manufacturing.

### BACKGROUND

With the continuous development of laser projection technology, laser TVs have received widespread attention and recognition from consumers due to their advantages such as small size, large projection area, and low cost, and the market has expanded year after year. Although the current laser TV luminous flux has reached a very high level, the contrast of the projection screen is not satisfactory under the influence of ambient light. So far a variety of screens with anti-light effects have appeared on the market, in which black matrix projection screens have received widespread attention and use due to their advantages such as good anti-light effects and relatively low cost.

Chinese patent CN107297928 discloses an optical cloth, a coating device and a coating method, which accurately prepare a colorless and transparent microprism grating with a prism structure on the surface of acrylic by die-casting or UV curing (ultraviolet curing) transfer technology, then spray a reflective paint on one inclined surface of the prism structure while trying to avoid another inclined surface of the prism structure from being splashed by the paint, and after the reflective paint is dried, spray a black light-absorbing paint on the other inclined surface while preventing the black light-absorbing paint from being splashed onto the reflective paint. Since the prism structure is relatively small, it is difficult to complete the spraying operation of the above process manually, and an extremely precise machine is required to realize the preparation of the black matrix projection screen. The production cost is high and the production efficiency is low.

Chinese patent CN2718623Y discloses a precise black matrix display projection screen, the light-absorbing surface of the prism structure of which is obtained by a dyeing process, and the dyeing process is complicated and costly.

### SUMMARY

A composite paint for a projection screen, characterized in that the composite paint for the projection screen includes a light-absorbing paint and a reflective paint,

the light-absorbing paint includes following components:

28-32 parts by weight of acrylate;

28-32 parts by weight of an active diluent;

1-3 parts by weight of a photoinitiator;

1-3 parts by weight of a black pigment;

20-28 parts by weight of a solvent; and

1-5 parts by weight of an aid;

the reflective paint includes following components:

28-32 parts by weight of acrylate;

28-32 parts by weight of an active diluent;

1-3 parts by weight of a photoinitiator;

18-23 parts by weight of an aluminum silver powder;

26-32 parts by weight of a solvent; and

1-5 parts by weight of an aid,

wherein the photoinitiator is a compound with an initiating activity under ultraviolet light or visible light.

A preparation method for a projection screen, characterized in that the preparation method includes:

S1: preparing a projection screen substrate having a plurality of prism microstructures, each of the plurality of prism microstructures having a first flat surface and a second flat surface that intersect with each other;

S2: coating one paint of a light-absorbing paint and a reflective paint on a side of the projection screen substrate with the plurality of prism microstructures, photocuring the one paint on the first flat surfaces, and after the photocuring is completed, washing away the one paint on the second flat surfaces using a cleaning solvent; and

S3: coating the other paint of the light-absorbing paint and the reflective paint on the side of the projection screen substrate with the plurality of prism microstructures, photocuring the other paint on the second flat surfaces, and after the photocuring is completed, washing away the paint on the first flat surfaces using a cleaning solvent.

The technical solutions of the present disclosure will be described in detail below with reference to the drawings and specific embodiments.

### BRIEF DESCRIPTION OF DRAWINGS

FIG. 1 illustrates a process flow diagram of a method for preparing a projection screen of the present disclosure.

### DESCRIPTION OF EMBODIMENTS

The technical problem to be solved by the present disclosure is to provide a composite paint for a projection screen and a preparation method for a projection screen in view of the deficiencies of the prior art. Different sides of the prism microstructures are coated in stages using the photocuring technology, and a projection screen composite paint suitable for stage coating is provided. The projection screen prepared by this method is formed to obtain an optical screen with good light resistance without dyeing and a complex plane roller device, thereby achieving the high brightness and high contrast of the laser TV projection screen with the advantages of saving energy, environmental friendliness, simple process and low cost compared with the prior art.

The technical problem to be solved by the present disclosure is achieved through the following technical solutions.

The present disclosure provides a composite paint for a projection screen, the composite paint for the projection screen includes a light-absorbing paint and a reflective paint, and the light-absorbing paint includes the following components in parts by weight:

28-32 parts by weight of acrylate;

28-32 parts by weight of an active diluent;

1-3 parts by weight of a photoinitiator;

1-3 parts by weight of a black pigment;

20-28 parts by weight of a solvent; and

1-5 parts by weight of an aid;

the reflective paint includes the following components in parts by weight:

28-32 parts by weight of acrylate;

28-32 parts by weight of an active diluent;

1-3 parts by weight of a photoinitiator;

18-23 parts by weight of an aluminum silver powder;

26-32 parts by weight of a solvent; and

1-5 parts by weight of an aid,

the acrylate is one or more of polyurethane acrylate, polyester acrylate, polyether acrylate, or epoxy acrylate, and the acrylate is a film-forming material, has good adhesion to the aluminum silver powder, and can further increase the adhesion of the paint on the screen.

The active diluent is selected from methacrylate compounds, and is specifically one or more of methyl methacrylate (MMA), butyl acrylate (BA), isodecyl acrylate (IDA), lauryl acrylate (LA), isooctyl acrylate (EHA), trimethylolpropane triacrylate (TMPTA), trimethylolpropane trimethacrylate (TMPTMA), pentaerythritol triacrylate (PETA), or hexanediol diacrylate (HDDA). The active diluent is configured to adjust the viscosity of the screen paint to facilitate subsequent grinding. The active diluent is also called a reactive solvent, which is a compound configured to dissolve or disperse the film-forming material, participate in the film-forming reaction during the film-forming process of the paint, and form a non-volatile component that remains in the coated film. The active diluent may participate in the curing reaction of the epoxy resin and become a part of the cross-linked network structure of the cured epoxy resin.

The photoinitiator is a compound with an initiating activity under ultraviolet light or visible light. For example, the photoinitiator includes, but is not limited to, one or more of camphorquinone, fluorodiphenyl titanocene, bis(pentafluorophenyl) titanocene, diaryliodonium salt, triaryliodonium salt, alkyliodonium salt, or cumene hexafluorophosphate ferrocene. The photoinitiator is configured to absorb the energy of the radiant light band to initiate polymerization, crosslinking and curing of the monomers.

The black pigment is any one of carbon black, iron black, and aniline black. An average particle diameter of the black pigment is within a range of 20 nm-2000 nm, preferably 20 nm-200 nm, further preferably 20 nm-50 nm.

The solvent is one or more of alcohols, esters, ethers, aliphatic hydrocarbons, or aromatic hydrocarbons. It is noted that the solvent in the light-absorbing paint and the solvent in the reflective paint may be the same or different.

The aid includes one or more of a dispersant, a leveling agent, a defoamer, or a polymerization inhibitor. It is noted that the aid in the light-absorbing paint and the aid in the reflective paint may be the same or different.

Specifically, the leveling agent is an organosilicone leveling agent or a fluorocarbon leveling agent, and the leveling agent can effectively reduce the surface tension of the paint, such that the paint forms a flat, smooth and uniform film during the film forming process.

The defoamer is one or more of ethanol, n-butanol, organosilicone ester, mineral oil, or lecithin, and the defoamer can effectively reduce the surface tension of the contact point to destroy the foam film and achieve defoaming effect.

The polymerization inhibitor is one or more of phenothiazine, 4-methoxyphenol, hydroquinone, phenylnaphthylamine, or p-tert-butylcatechol, and the polymerization inhibitor can prevent free radicals of allyl monomers from polymerizing.

The dispersant is a surfactant with two opposite properties, i.e. lipophilicity and hydrophilicity, in the molecules, and is configured to improve the dispersion of solid raw materials in the paint liquid while preventing sedimentation and agglomeration of particles.

Specifically, the dispersant may adopt fatty acids, aliphatic amides and lipids well-known in the art, such as stearamide, N-ethylene bis-stearamide, glyceryl monostearate (GMS), glyceryl tristearate (HTG) and so on.

The aluminum silver powder may be of a floating type, and the aluminum silver powder of floating type has a flake structure with a particle diameter of 3 μm-15 μm, preferably 3 μm-8 μm. The aluminum silver powder is configured to reflect light to improve the light utilization of the projection screen and further improve the light gain of the projection screen.

### Preparation of the Light-Absorbing Paint of the Present Disclosure

Raw materials of the light-absorbing paint, 30 parts by weight of polyurethane acrylate, 30 parts by weight of hexanediol diacrylate, 2 parts by weight of camphorquinone, 2 parts by weight of acetylene carbon black, and 25 parts by weight of the solvent, were weighed. The solvent contains 10 parts by weight of xylene, 12 parts by weight of butyl acetate, 3 parts by weight of cyclohexanone, and 1 part by weight of the aid. The aid includes 0.3 parts by weight of the leveling agent, 0.3 parts by weight of the polymerization inhibitor, and 0.4 parts by weight of the defoamer.

Step 1: 30 parts by weight of polyurethane acrylate, 10 parts by weight of xylene, 12 parts by weight of butyl acetate, 3 parts by weight of cyclohexanone, 30 parts by weight of hexanediol diacrylate were weighed, and stirred evenly at room temperature to obtain a resin matrix.

Step 2: 2 parts by weight of acetylene carbon black and the resin matrix obtained in the step 1 were mixed, and ground with a grinder until the black pigment was completely dispersed.

Step 3: the black resin matrix in the step 2 was stirred at a low stirring speed that is less than 500 r/min, and 0.3 parts by weight of the leveling agent, 0.3 parts by weight of the polymerization inhibitor, and 0.4 parts by weight of the defoamer were added in sequence.

Step 4: 2 parts by weight of camphorquinone was added to the composition obtained in the step 3, stirred under dark conditions, and mixed uniformly to form the paint, which was stored away from light for use.

The photoinitiator can be selected according to the wavelength of the specific light conditions, which is a common technology in the field of photocuring, and will not be described herein.

### Preparation of the Reflective Paint of the Present Disclosure

20 parts by weight of polyurethane acrylate, 30 parts by weight of hexanediol diacrylate, 1 part by weight of camphorquinone, 20 parts by weight of the aluminum silver powder, 28 parts by weight of solvent, so that raw materials of the reflective paint were weighed. The solvent contains 13 parts by weight of xylene, 12 parts by weight of butyl acetate, 3 parts by weight of cyclohexanone, and 1 part by weight of the aid, and the aid includes 0.3 parts by weight of the leveling agent, 0.3 parts by weight of the polymerization inhibitor, and 0.4 parts by weight of the defoamer.

Step 1: 20 parts by weight of the aluminum silver powder was weighed and soaked in 15 parts by weight of hexanediol diacrylate for 8 hours.

Step 2: 20 parts by weight of polyurethane acrylate, 10 parts by weight of xylene, 12 parts by weight of butyl acetate, 3 parts by weight of cyclohexanone, and the remaining half of 15 parts by weight of hexanediol diacrylate were weighed and stirred evenly at room temperature to obtain a resin matrix.

Step 3: the aluminum silver powder solution obtained in the step 1 and the resin matrix in the step 2 were stirred at a low stirring speed that is less than 500 r/min, and 0.3 parts by weight of the leveling agent, 0.3 parts by weight of the polymerization inhibitor, and 0.4 parts by weight of the defoamer were added in sequence.

Step 4: 2 parts by weight of camphorquinone was added to the composition obtained in the step 3, stirred under dark conditions, and mixed uniformly to form the paint, which was stored away from light for use.

The photoinitiator may be selected according to the wavelength of the specific light conditions, which is a common technology in the field of photocuring, and will not be described herein.

The preparation method for the anti-light screen of the present disclosure is specifically illustrated below.

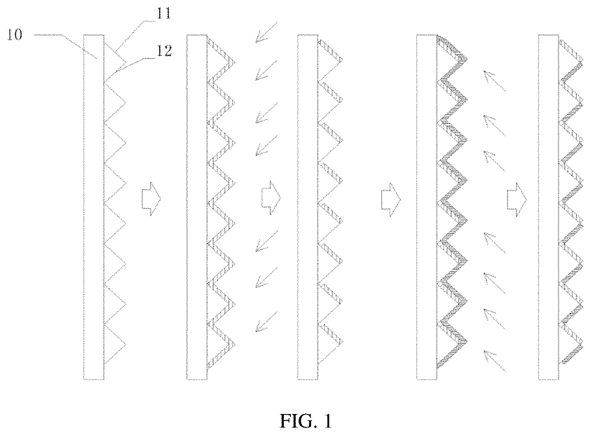

FIG. 1 illustrates a process flow diagram of a preparation method for a projection screen of the present disclosure. As shown in FIG. 1, the present disclosure also provides a preparation method for the above projection screen, and the preparation method includes:

S1: preparing a projection screen substrate 10 having a plurality of prism microstructures, each of the prism microstructures having a first flat surface 11 and a second flat surface 12 that intersect with each other;

S2: coating one paint of the light-absorbing paint and the reflective paint on a side of the projection screen substrate with the prism microstructures, photocuring the one paint on the first flat surfaces 11, and after the photocuring is completed, washing away the one paint on the second flat surfaces 12 using a cleaning solvent; and

S3: coating the other paint of the light-absorbing paint and the reflective paint on the side of the projection screen substrate with the prism microstructures, photocuring the other paint on the second flat surfaces 12, and after the photocuring is completed, washing away the other paint on the first flat surfaces 11 using a cleaning solvent.

In the S1, specifically, the plurality of first flat surfaces 11 are parallel to each other, the plurality of second flat surfaces 12 are parallel to each other, and the first flat surfaces 11 and the second flat surfaces 12 are alternately arranged on one side of the projection screen substrate, and together form an outer surface of the one side of the projection screen substrate. The angles between the first flat surfaces 11, the second flat surfaces 12 and the projection screen substrate 10 are not limited in the present disclosure, and may be adjusted by those skilled in the art in accordance with actual requirements. The projection screen substrate with the plurality of prism microstructures may be manufactured in a variety of ways in the prior art, which will not be repeated in the present disclosure.

The method for coating the paint on the projection screen substrate includes, but is not limited to, spray coating, roll coating, blade coating, and screen printing, preferably spray coating and screen printing, and more preferably spray coating.

In the S2 and S3, the light source for photocuring may be ultraviolet light or visible light, which is related to the type of the photoinitiator in the light-absorbing paint and the reflective paint. The process parameters of photocuring is not limited in the present disclosure, and a suitable photocuring process may be selected by those skilled in the art based on types of the light-absorbing paint and the reflective paint.

When cleaning the uncured paint, a solvent may be used for cleaning, preferably the solvent in the light-absorbing paint or the solvent in the reflective paint.

The method for coating the composite paint for the projection screen of the present disclosure will be further described below in conjunction with specific embodiments.

Firstly, a projection screen substrate with a plurality of prism microstructures was prepared, the light-absorbing paint was sprayed on a side of the projection screen substrate with the prism microstructures, the light-absorbing paint on the first flat surfaces was photocured, and after the photocuring was completed, the light-absorbing paint on the second flat surfaces was cleaned to form a light-absorbing layer on the projection screen substrate; the reflective paint was sprayed on the side of the projection screen substrate with the prism microstructures, the reflective paint located on the second flat surfaces was photocured, and after the photocuring was completed, the reflective paint located on the first flat surfaces was cleaned to form a reflective layer on the projection screen substrate.

To sum up, the present disclosure adopts the photocuring technology to coat different sides of the prism microstructures in stages, and provides a projection screen composite paint suitable for stage coating. The projection screen prepared by this method may be formed to obtain an optical screen with good light resistance without dyeing or a complex plane roller device, thereby achieving the high brightness and high contrast of the laser TV projection screen with the advantages of saving energy, environmental friendliness, simple process and low cost compared with the prior art.

1. A composite paint for a projection screen, wherein the composite paint for the projection screen comprises a light-absorbing paint and a reflective paint,
the light-absorbing paint comprises following components:
28-32 parts by weight of acrylate;
28-32 parts by weight of an active diluent;
1-3 parts by weight of a photoinitiator;
1-3 parts by weight of a black pigment;
20-28 parts by weight of a solvent; and
1-5 parts by weight of an aid,
the reflective paint comprises following components:
28-32 parts by weight of acrylate;
28-32 parts by weight of an active diluent;
1-3 parts by weight of a photoinitiator;
18-23 parts by weight of an aluminum silver powder;
26-32 parts by weight of a solvent; and
1-5 parts by weight of an aid, and
wherein the photoinitiator is a compound with an initiating activity under ultraviolet light or visible light.

2. The composite paint for the projection screen according to claim 1, wherein the acrylate of the light-absorbing paint or the acrylate of the reflective paint is one or more of polyurethane acrylate, polyester acrylate, polyether acrylate, or epoxy acrylate.

3. The composite paint for the projection screen according to claim 1, wherein the active diluent is one or more of methyl methacrylate, butyl acrylate, isodecyl acrylate, lauryl acrylate, isooctyl acrylate, trimethylolpropane triacrylate, trimethylolpropane trimethacrylate, pentaerythritol triacrylate, or hexanediol diacrylate.

4. The composite paint for the projection screen according to claim 1, wherein the black pigment is carbon black, iron black or aniline black, and an average particle diameter of the black pigment is within a range of 20 nm-2000 nm.

5. The composite paint for the projection screen according to claim 1, wherein the solvent is one or more of alcohols, esters, ethers, aliphatic hydrocarbons, or aromatic hydrocarbons.

6. The composite paint for the projection screen according to claim 1, wherein the aid comprises one or more of a dispersant, a leveling agent, a defoamer, or a polymerization inhibitor.

7. The composite paint for the projection screen according to claim 1, wherein the aluminum silver powder has a shape of flake, and an average particle diameter of the aluminum silver powder is within a range of 3 μm-15 μm.

8. A preparation method for a projection screen, comprising:
S1: preparing a projection screen substrate having a plurality of prism microstructures, each of the plurality of prism microstructures having a first flat surface and a second flat surface that intersect with each other;
S2: coating one paint of a light-absorbing paint and a reflective paint on a side of the projection screen substrate with the plurality of prism microstructures, photocuring the one paint on the first flat surfaces, and after the photocuring is completed, washing away the one paint on the second flat surfaces using a cleaning solvent; and
S3: coating the other paint of the light-absorbing paint and the reflective paint on the side of the projection screen substrate with the plurality of prism microstructures, photocuring the other paint on the second flat surfaces, and after the photocuring is completed, washing away the other paint on the first flat surfaces using a cleaning solvent,
wherein the light-absorbing paint comprises following components:
28-32 parts by weight of acrylate;
28-32 parts by weight of an active diluent;
1-3 parts by weight of a photoinitiator;
1-3 parts by weight of a black pigment;
20-28 parts by weight of a solvent; and
1-5 parts by weight of an aid,
the reflective paint comprises following components:
28-32 parts by weight of acrylate;
28-32 parts by weight of an active diluent;
1-3 parts by weight of a photoinitiator;
18-23 parts by weight of an aluminum silver powder;
26-32 parts by weight of a solvent; and
1-5 parts by weight of an aid, and
wherein the photoinitiator is a compound with an initiating activity under ultraviolet light or visible light.

9. The preparation method according to claim 8, wherein the coating comprises spray coating, roll coating, blade coating, or screen printing.

10. The preparation method according to claim 8, wherein a light source for the photocuring is ultraviolet light or visible light.

11. The composite paint for the projection screen according to claim 4, wherein the average particle diameter of the black pigment is within a range of 20 nm-200 nm.

12. The composite paint for the projection screen according to claim 7, wherein the average particle diameter of the aluminum silver powder is within a range of 3 μm-8 μm.

13. The preparation method for the projection screen according to claim 8, wherein the acrylate of the light-absorbing paint or the acrylate of the reflective paint is one or more of polyurethane acrylate, polyester acrylate, polyether acrylate, or epoxy acrylate.

14. The preparation method for the projection screen according to claim 8, wherein the active diluent is one or more of methyl methacrylate, butyl acrylate, isodecyl acrylate, lauryl acrylate, isooctyl acrylate, trimethylolpropane triacrylate, trimethylolpropane trimethacrylate, pentaerythritol triacrylate, or hexanediol diacrylate.

15. The preparation method for the projection screen according to claim 8, wherein the black pigment is carbon black, iron black or aniline black, and an average particle diameter of the black pigment is within a range of 20 nm-2000 nm.

16. The preparation method for the projection screen according to claim 15, wherein the average particle diameter of the black pigment is within a range of 20 nm-200 nm.

17. The preparation method for the projection screen according to claim 8, wherein the solvent is one or more of alcohols, esters, ethers, aliphatic hydrocarbons, or aromatic hydrocarbons.

18. The preparation method for the projection screen according to claim 8, the aid comprises one or more of a dispersant, a leveling agent, a defoamer, or a polymerization inhibitor.

19. The preparation method for the projection screen according to claim 8, wherein the aluminum silver powder has a shape of flake, and an average particle diameter of the aluminum silver powder is within a range of 3 μm-15 μm.

20. The preparation method for the projection screen according to claim 19, wherein the average particle diameter of the aluminum silver powder is within a range of 3 μm-8 μm.
